(19) United States
(12) Patent Application Publication
(10) Pub. No.: US 2002/0186242 A1
(43) Pub. Date: Dec. 12, 2002

(54) Image input control method, information processing apparatus, storage medium, and program

(75) Inventor: Koichi Abe, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/157,928

(22) Filed: May 31, 2002

(30) Foreign Application Priority Data
Jun. 7, 2001 (JP) 172596/2001
Feb. 14, 2002 (JP) 037038/2002

(51) Int. Cl. G09G 5/00

(52) U.S. Cl. 345/746

(57) ABSTRACT

An image input control method, an information processing apparatus, a storage medium, and a program are provided. Image data received from the image input device is stored in a storage unit, and the image data stored in the storage unit is displayed on a display unit. After the image data is displayed, the image data stored in the storage unit is compressed, and the compressed image data is stored in the storage unit.

### BACKGROUND OF THE INVENTION

1. Field of the Invention

The present invention relates to an image input control method, an information processing apparatus, a storage medium, and a program, for processing image data from an image input device.

2. Description of the Related Art

An image reading system is known in the art in which an image input device such as a reading device (e.g., a scanner) capable of reading an original document is connected to a personal computer, and by using the personal computer as a host, the image data read by the reading device is transferred to the personal computer, where the image data is loaded as an image file.

In this type of system, reading an image, displaying scanning information, a scanning operation by a user, etc., are controlled by a scanner application running on a personal computer. A user interface is displayed on the display screen of the personal computer in accordance with the scanner application, so that during a scanning operation, the resolution and the scanning image size are set and then the start button is pressed, making it possible to perform scanning. Also, there is a viewer for displaying the scanned image on the user interface, so that the user can check the scanned image. By using such a user interface, the ease of operation is improved, and a desired scanned image can be obtained.

Furthermore, in such a system, a personal computer typically has a hard disk drive capable of storing several GB of data as a large-capacity storage device. Therefore, for example, since the size of the image data when an original A4 document is read at 300 dpi in color is approximately 24 MB, from the viewpoint of the system, there is no risk of problems such as insufficient space for storing image data; therefore, the construction is formed without a problem.

Meanwhile, in recent years, a simplified personal computer (hereinafter referred to as a “handheld personal computer”) is known which does not have a large-capacity storage device such as a hard disk drive but instead has only a memory (a RAM) usually capable of storing several tens of MB of data. It has been proposed that this type of handheld personal computer be used as a host and a reading device be connected as an image input device to construct the above-described reading system.

However, in such a system, there is a case in which the size of the data which can be stored in a handheld personal computer is smaller than the size of the data of the read image. In this case, it becomes necessary to perform a setting operation to make the size of the image data fall within the capacity of the storage device, and thus various problems arise, such as reduced ease of operation or the inability to correctly store data even though a reading operation was performed. In particular, in the case of a reading device capable of scanning a color document (an image), it is necessary to handle the read image data at almost the same unit size as the memory capacity (RAM) of the handheld personal computer. For this reason, in the conventional system, it is difficult to realize a system in which the ease of operation for the user is improved and in which the functions of the reading device can be fully exhibited.

By taking such problems into consideration, a system is disclosed in Japanese Unexamined Patent Application Publication No. 10-116339 in which the ease of operation for a user is improved and the functions of the reading device can be fully exhibited. In this system, when the image data to be read is larger than a free space (which, in this specification, refers to the size of the free area of a data storage means) of the memory (RAM) of a personal computer, the scanning settings (referred to in this specification as scanning conditions) are changed. Furthermore, in this conventional technology, the operations described below are required until the scanning is complete:

(1) An original document is set.

(2) The scanning conditions are set.

(3) Scanning is performed (a scanning button is pressed).

(4) The size of image data to be read is compared with the size of the free area of the data storage means.

(5) When the size of the image data to be read is larger than the size of the free area of the data storage means, the scanning conditions are changed so that reading within the range of the size of the free area of the data storage means becomes possible (in the main window, the scanning conditions after this change are displayed).

(6) Scanning is performed again (the scanning button is pressed).

(7) The reading is completed.

This completes the reading. After operation (7), the read image data is displayed in the main window, and, based on the selection specification by the user, the read image data is stored on the hard disk.

With the above construction, in the system, the ease of operation for the user is improved, and the functions of the reading device can be fully exhibited.

However, in the above-described system, as in operation (5) above, the scanning settings must always be set so that scanning within the range of the size of the free area of the data storage means becomes possible. For this reason, problems arise, in that often reading cannot be performed with the scanning settings desired by the user.

Furthermore, the size of a display buffer which can be used to display a viewer is limited, and a problem arises in that, when a large image is read, the viewer display cannot be adequately performed.

### SUMMARY OF THE INVENTION

The present invention has been made to solve the above-described problems. An object of the present invention is to provide an image input control method, an information processing apparatus, a storage medium, and a program, which are capable of displaying and storing a desired input image without performing a complex operation by an operator even when the size of a storage area is not sufficient.

To achieve the above-mentioned object, in one aspect, the present invention provides an image input control method for use with an information processing apparatus which can communicate with an image input device for inputting image data via a communication medium and which has storage means and display means, the image input control method comprising: a first storing step of storing image data received from the image input device in the storage means; a display step of displaying on the display means the image data stored in the storage means in the first storing step; a compression step of compressing the image data stored in the storage means in the first storing step after the image data is displayed in the display step; and a second storing step of storing in the storage means the image data compressed in the compression step.

Another object of the present invention is to provide an image input control method, an information processing apparatus, a storage medium, and a program, which are capable of performing reading at high speed with desired scanning settings regardless of the size of the free space in the memory.

To achieve the above-mentioned object, in another aspect, the present invention provides an image input control method for use with an information processing apparatus which can communicate with an image input device for inputting image data via a communication medium and which has storage means, the image input control method comprising: a computation step of computing the amount of image data input by the image input device; a first determination step of determining the relationship between the size of the amount of image data computed in the computation step and the size of the free space of the storage means; a compression step of compressing the image data received from the image input device when it is determined in the first determination step that the amount of image data is larger than the size of the free space of the storage means; and a storing step of storing in the storage means the image data compressed in the compression step.

Another object of the present invention is to provide an image input control method, an information processing apparatus, a storage medium, and a program, which allow an input image to be reliably displayed even when the size of a display storage area is not sufficient.

To achieve the above-mentioned object, in another aspect, the present invention provides an image input control method for use with an information processing apparatus which can communicate with an image input device for inputting image data via a communication medium and which has storage means and display means, the image input control method comprising: a storing step of sequentially receiving image data input from the image input device and storing the input image data in the storage means; and a display step of displaying on the display means the image data stored in the storage means, wherein, when the amount of input image data is larger than the size of the storage means, the input image data is stored in the storing step in such a manner as to be divided according to the size of the storage means, and the image data is displayed in sequence, in the display step, by the amount corresponding to divided input image data stored in the storage means.

Further objects, features, and advantages of the present invention will become apparent from the following description of the preferred embodiments with reference to the attached drawings.

### BRIEF DESCRIPTION OF THE DRAWINGS

FIG. 1 shows the configuration of an image reading system according to the present invention.

FIG. 2 is a block diagram showing the internal hardware construction of a handheld personal computer 1.

FIG. 3 is a block diagram showing the internal hardware construction of a scanner 5.

FIG. 4 is a block diagram showing the structure of a scanner application for controlling the scanner 5.

FIG. 5 shows the UI of a scanner application 20.

FIG. 6 shows the UI of the scanner application 20.

FIG. 7 shows the UI of the scanner application 20.

FIG. 8 shows the UI of the scanner application 20.

FIG. 9 shows a method of using a display band buffer.

FIG. 10 is a flowchart showing a process after reading is started in a first embodiment.

FIG. 11 is a flowchart showing a process for displaying an image for one band, which is read in the first embodiment, and for storing the image.

FIG. 12 shows an insufficient available memory error message.

FIG. 13 is a flowchart showing a process after reading is started in a second embodiment.

FIG. 14 is a flowchart showing a process for checking free memory.

FIG. 15 is a flowchart showing a process for displaying an image for one band, which is read in the second embodiment, and for storing the image.

### DETAILED DESCRIPTION OF THE PREFERRED EMBODIMENTS

Embodiments of the present invention will be described below with reference to the drawings.

(First Embodiment)

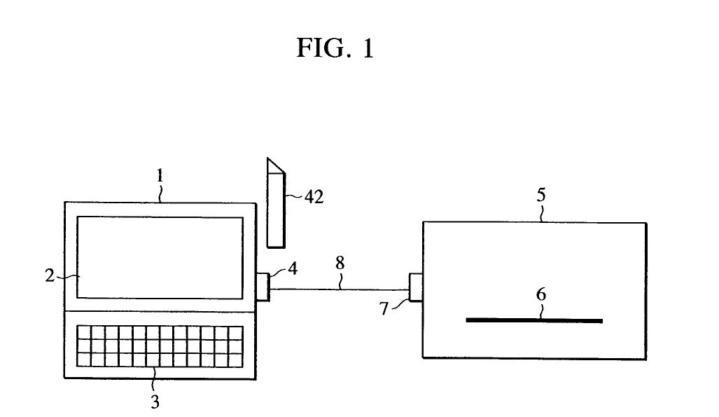

FIG. 1 shows the configuration of an image reading system according to the present invention. Referring to FIG. 1, reference numeral 1 denotes a handheld personal computer, the OS installed therein being Microsoft Windows CE. Reference numeral 2 denotes a liquid-crystal display. Reference numeral 3 denotes a keyboard. Reference numeral 4 denotes a USB port (host) 4. USB is an abbreviation for Universal Serial Bus, and since it is a well-known interface by which two-way communication is possible, a detailed description thereof is omitted. The liquid-crystal display 2 is formed as a touch panel in which, by performing operations such as dragging, dropping, tapping, etc. using a stylus pen 42, functions similar to those of a mouse for a personal computer are realized.

Reference numeral 5 denotes a sheet-feed-type color scanner. Reference numeral 6 denotes an original-document insertion slot 6. Reference numeral 7 denotes a USB port (client). The handheld personal computer 1 and the scanner 5 are connected to each other by a USB cable 8, and two-way communication of data is possible between these devices.

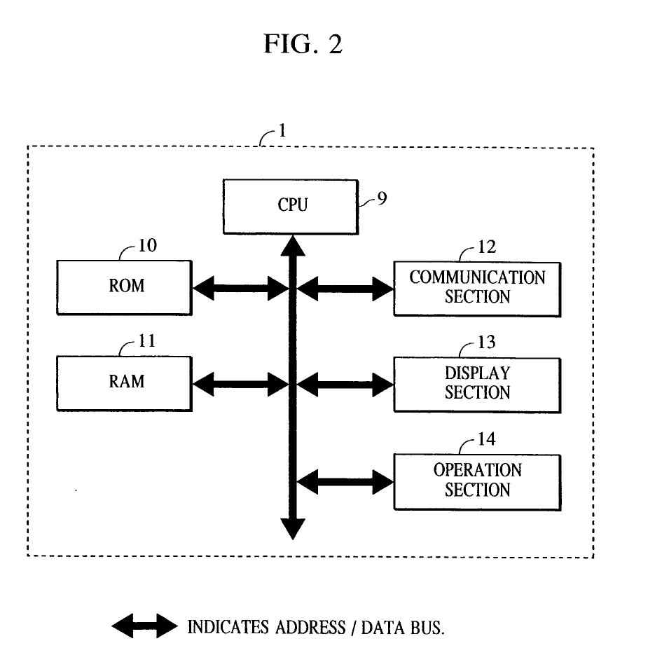

FIG. 2 is a block diagram showing the internal hardware construction of the handheld personal computer 1. The handheld personal computer 1 is a portable terminal used as a simplified personal computer, and the main features thereof are that a large-capacity storage device like a hard disk drive (usually a device capable of storing several GB of data) is not provided but only a RAM is provided as storage means.

In FIG. 2, reference numeral 9 denotes a CPU formed of a microcomputer, etc. The CPU 9 functions as a central processing unit of the handheld personal computer 1 and controls a RAM 11, the communication section 12, the display section 13, and the operation section 14 in accordance with a program stored in the ROM 10. In the ROM 10, each device driver for controlling the OS, the display, and the ports and each application which can be activated in the handheld personal computer 1, etc., are prestored. The RAM 11 is usually formed with a capacity of approximately 32 MB, half thereof being allocated for program execution and the other half being allocated for data storage. The communication section 12 includes the USB port 4 and controls USB communication. The display section 13 includes the liquid-crystal display 2 and controls the user interface display (hereinafter sometimes abbreviated as “UI”) for an application, etc. The operation section 14 includes the keyboard 3 and controls key inputs.

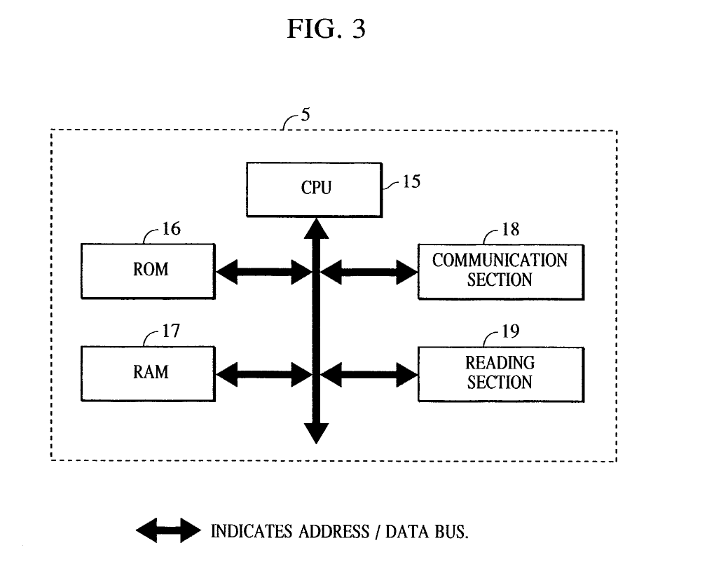

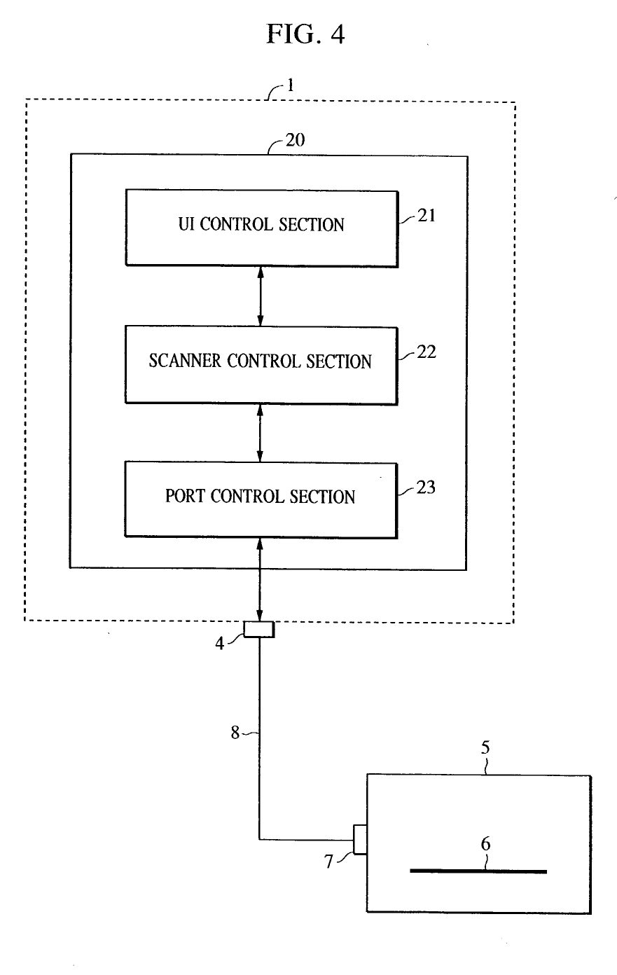

FIG. 3 is a block diagram showing the internal hardware construction of the scanner 5. Referring to FIG. 3, reference numeral 15 denotes a CPU formed of a microprocessor, etc. The CPU 15 functions as a central processing unit for the scanner 5 and controls a RAM 17, a communication section 18, and an operation section 19 in accordance with a program stored in the ROM 16. In the ROM 16, a program is stored by which the scanner 5 performs a reading process under the control of the scanner application 20 (to be described later with reference to FIG. 4). The RAM 17 is used to temporarily store image data which is read mainly by the reading section 19. The communication section 18 includes the USB port 7 and controls USB communication. The reading section 19 includes the original-document insertion slot 6, and is formed of a reading unit composed of CCDs, an ASIC for processing read data into image data, etc.

The original document inserted from the original-document insertion slot 6 is read by the reading section 19 under the control of the scanner application 20. The read data is processed into image data, after which the data is temporarily stored in the RAM 17 and is sent from the USB port 7 to the handheld personal computer 1 via the USB interface. This image data to be transferred is not subjected to compression at this time, and is actual data. The image data received by the handheld personal computer 1 is stored in the data storing area of the RAM 11, as will be described later.

FIG. 4 is a block diagram showing the structure of a scanner application for controlling the scanner 5. In FIG. 4, the arrow indicates the flow of data. Reference numeral 20 denotes a scanner application, which is stored in the ROM 10 of the handheld personal computer 1, which is executed by the CPU 9, and which exists in the RAM 11 during execution. Reference numeral 21 denotes a UI control section, which controls the UI of the scanner application 20. Reference numeral 22 denotes a scanner control section, which sends a control command to the scanner 5 in accordance with an instruction from the UI control section 21 in order to control the scanner 5 and in order to report the status of the scanner 5 to the UI control section 21. Reference numeral 23 denotes a port control section, which writes a control command issued from the scanner control section into the communication section 12, which reads, from the communication section 12, a response command from the scanner 5, and which performs the control of the ports when viewed mainly from the application level.

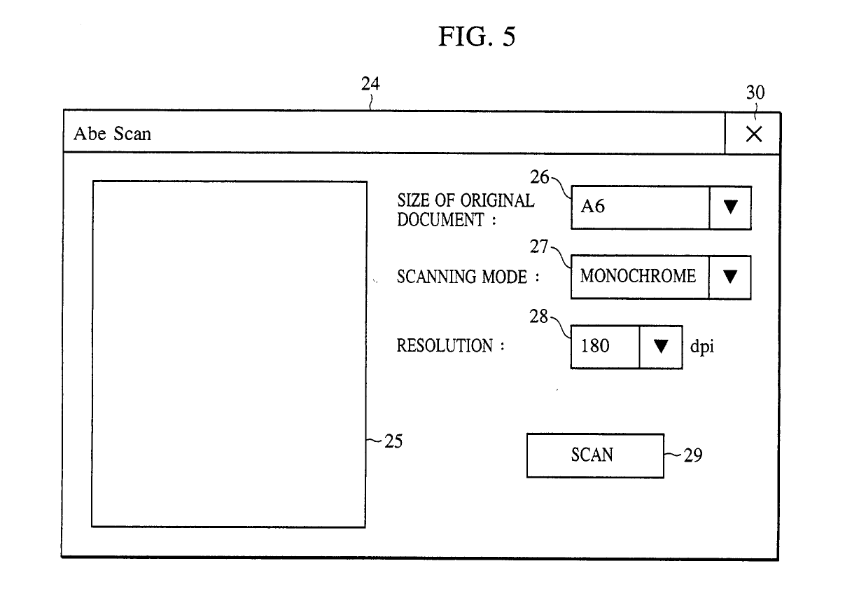

FIG. 5 shows the UI of the scanner application 20. When the scanner application 20 is running, this state is displayed on the liquid-crystal display 2 of the handheld personal computer 1. FIG. 5 also shows the display contents when the scanner 5 is on standby. Referring to FIG. 5, reference numeral 24 denotes a main window. Reference numeral 25 denotes a viewer for displaying image data read by the scanner 5. Here, when displaying the image data, a display band buffer with a size of 1 MB for displaying the viewer 25 is provided in the program execution area of the memory (the RAM 11), and by using this buffer, a desired image can be displayed. The details of a display method will be described later. While the scanner application 20 is running, the display band buffer is always allocated.

Reference numeral 26 denotes an original-document size selection section, which is formed of a combo box and which is capable of selecting one of three types of A6, A5, and A4 as the original-document size. Reference numeral 27 denotes a scanning mode selection section, which is formed of a combo box and which is capable of selecting one of three types of monochrome, grayscale, and color as the scanning mode. Reference numeral 28 denotes a resolution selection section, which is formed of a combo box and which is capable of selecting one of 90, 180, 200, 300, and 360 dpi as the resolution. Reference numeral 29 denotes an operation button, which functions as a scan button when not reading an image and functions as a cancel button while reading an image, and a character string displayed on the operation button 29 is switched. In FIG. 5, a character string “scan” is displayed, and when the operation button 29 is clicked on in this state, the reading of an image is started. Reference numeral 30 denotes a close button for closing the main window 24 and for terminating the scanner application 20. In the following description, the combination of settings in the original-document size selection section 26, the scanning mode selection section 27, and the resolution selection section 28 is referred to as “scanning settings”.

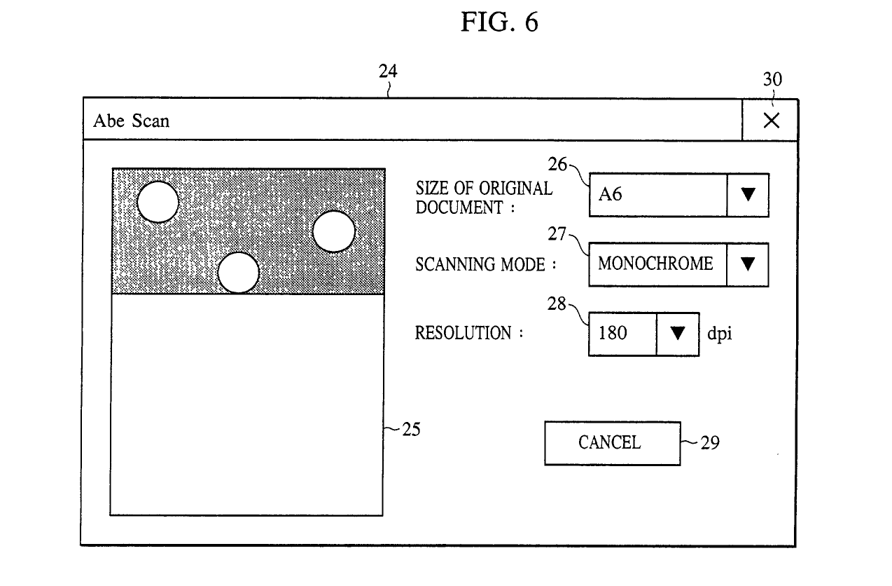

FIG. 6 shows the UI of the scanner application 20, and also shows the display contents while the scanner 5 is reading the image. In FIG. 6, the image data which is being read (in the middle of reading) is displayed on the viewer, and a character string “cancel” is displayed on the operation button 29. In this state, when the operation button 29 is clicked on, the reading of the image is stopped, and the images which have been read thus far are discarded.

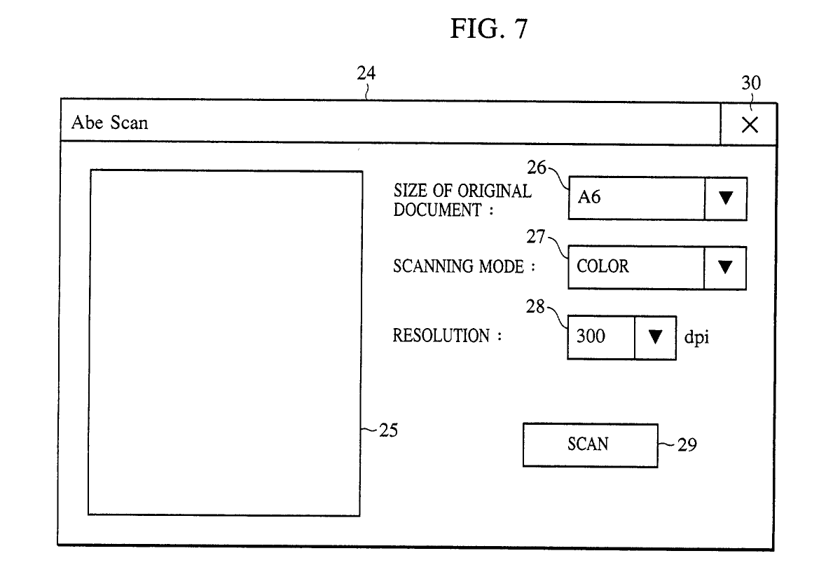

FIG. 7 shows the UI of the scanner application 20 while the scanner 5 is on standby, and also shows a state in which the original-document size is set to A6, the scanning mode is set to color, and the resolution is set to 300 dpi.

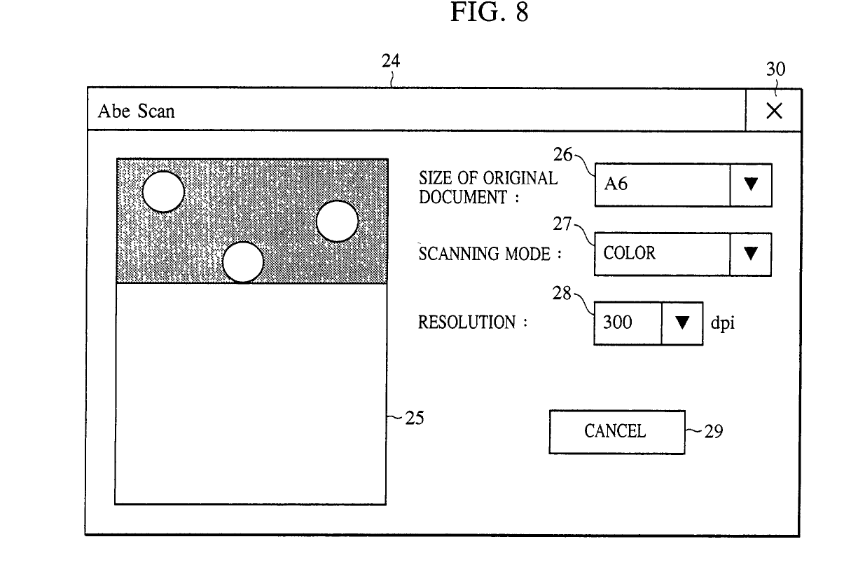

FIG. 8 shows the UI of the scanner application 20 while the scanner 5 is reading an image. FIG. 8 also shows a state in which the original-document size is set to A6, the scanning mode is set to color, and the resolution is set to 300 dpi, and the reading process continues, that is, shows a state in which the operation button 29 is clicked on in FIG. 7 and the reading of image is being performed.

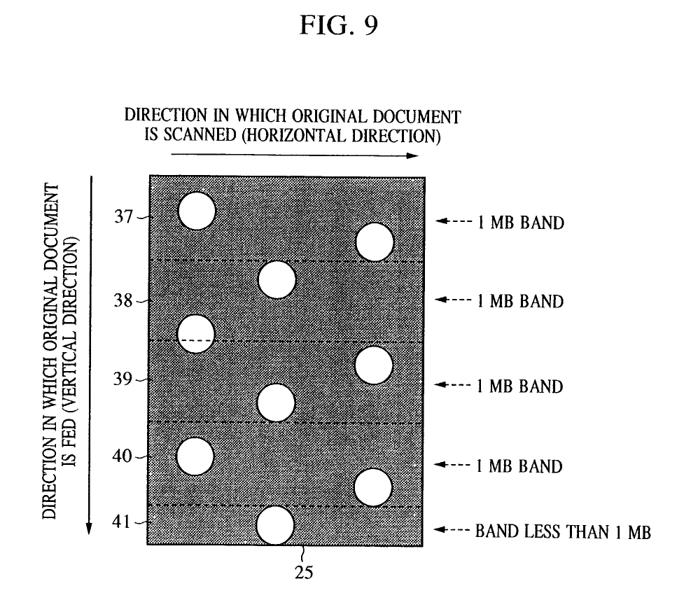

FIG. 9 shows a method of using a display band buffer when the image data read by the scanner 5 is displayed on the viewer 25. The image in FIG. 9 is obtained by reading the image printed on, for example, an original-document paper of A4 size. When it is assumed that the image of FIG. 9 is printed on the entire A4-size paper, the scanner 5 horizontally scans the original-document paper while vertically feeding the original-document paper in order to read the original-document image. Here, it is assumed that the number of lines read at one horizontal scanning (the number of pixels in the vertical direction) depends on the performance of the CCDs provided in the reading unit, and that the line width which is read at one scanning is smaller than the width in the vertical direction of each of areas 37 to 41 shown in FIG. 9. In this case, first, the image along the horizontal direction in the upper end of FIG. 9 is read, the original document is scanned in sequence from the upper portion of the image toward the lower portion, and finally, the image along the horizontal direction in the lower end is read.

In FIG. 9, reference numerals 37, 38, 39, 40, and 41 each denote a divided image when image data is divided into the size equal to or smaller than the display band buffer. It is assumed that the size of the actual image data when reading is performed with the scanning settings at this time is 4.5 MB (the size of the actual image data can also be computed on the basis of the scanning setting information before the reading is started). In this case, reference numerals 37, 38, 39, and 40 are each a band of image data of 1 MB, and reference numeral 41 is a band of image data of 0.5 MB. The image data is divided into a total of 5 bands, and this data is displayed as a result of being drawn in sequence on the viewer 25. Furthermore, when it is assumed that, for example, the size of the actual image data when reading is performed with the scanning settings of a particular time is 0.8 MB, the condition of the size of the actual image data (0.8 MB)<the size of the display band buffer (1 MB) is satisfied. Thus, the image data can be formed of one band in total, and is collectively drawn and displayed on the viewer 25.

In the manner described above, the scanner application determines the relationship between the size of the actual image data when reading is performed with the scanning settings at that time and the size of the display band buffer. Then, the actual image data is divided by a variable number of bands according to the result of this determination, and is drawn in sequence on the viewer 25 and is thus displayed.

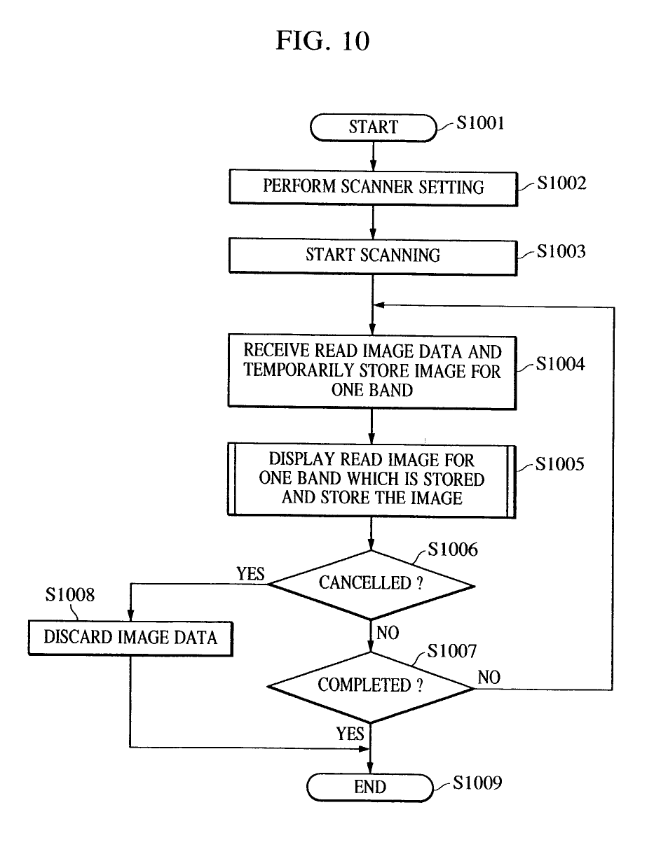

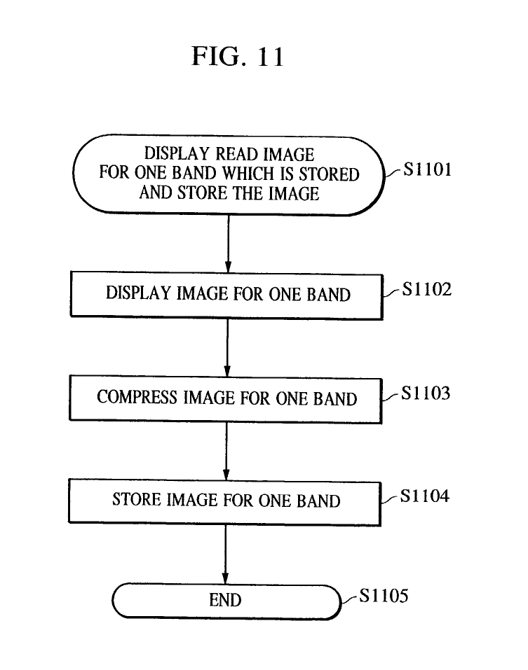

FIGS. 10 and 11 are flowcharts showing an operation (process) of this embodiment. The operation will now be described with reference to these figures. FIG. 10 is a flowchart showing a process after the operation button 29 is clicked on and reading is started. The process procedure shown in this flowchart is performed by the above-described scanner application.

First, in a state in which the scanner 5 is on standby, when the operation button 29 is clicked on and scanning is started (S1001), the scanning settings of the scanner 5 are performed in accordance with the scanning settings of the main window 24 (S1002), and the scanner 5 starts the reading of the original document set in the original-document insertion slot 6 (S1003).

Then, the image data read by the scanner 5 is received, and the image for one band (1 MB) is temporarily stored in the display band buffer (the program execution area of the RAM 11 which is a memory) (S1004).

Based on this stored image data for one band, the read image is displayed on the viewer 25. At this time, for example, only the image of the area 37 shown in FIG. 9 is displayed. Then, the image data is compressed and is stored in the data storing area of the memory (the RAM 11) (S1005).

When the operation button 29 is clicked on (cancel information is input) during the reading and the reading of the image is stopped (S1006), the image data which has been read and stored so far is discarded (S1008), and the process returns to the main window 24 (S1009).

When the reading of the image continues in step S1006 and when the reading is not completed (S1007), the process returns to step S1004, where the reading continues. Then, in step S1005 in the next loop, only the image of the area 38 is stored in the display band buffer and is displayed. That is, the image of the area 37 is erased from the screen, and only the image of the area 38 is displayed for preview.

When the reading of the image is completed in step S1007, the process returns to the main window 24 (S1009).

FIG. 11 is a flowchart showing a process for displaying the image for one band, which is read in step S1005 in FIG. 10 and for storing the image.

In a state in which the scanner 5 is on standby, the operation button 29 is clicked on and scanning is started. Based on the image data for one band, which is temporarily stored in the display band buffer, step S1101 is started.

Initially, based on the image data for one band, which is temporarily stored in the display band buffer, a read image for one band is drawn and displayed on the viewer 25 (S1102).

Next, the read image for one band displayed in step S1102 (the image data stored in the display band buffer) is compressed in accordance with the JPEG (Joint Photographic Coding Experts Group) compression format (S1103).

This compressed image for one band is stored in the data storing area of the memory (the RAM 11) (S1104). Here, if an image formed of a plurality of previous bands, which has already been stored, exists, one band is newly added to this image, and the image is stored as a combined compressed image.

Here, although the JPEG format is used as the compression format, since the JPEG format is a known compression format, a description thereof is omitted.

After the image is stored, the process proceeds to the next process, and a series of processes in step S1005 is terminated (S1105).

In the foregoing description, the operation in each state of the system is described as an embodiment of the present invention. In the manner described above, in this embodiment, when an image input device such as the scanner 5 required to process large volumes of image data is connected to the handheld personal computer 1 which is not provided with a large-capacity storage device such as a hard disk drive, the actual images read by the scanner 5 are temporarily stored in sequence in the display band buffer (the program execution area of the RAM 11 which is a memory). This actual image data is used to be drawn and displayed on the viewer 25, and this actual image data is compressed and stored in the data storing area of the memory (the RAM 11).

As a result, it is possible to realize an image reading system which has a high level of display and ease of operation, which can read an original document with a scanning settings in which the data reaches such a large size as to be incapable of being stored as actual image data in the handheld personal computer 1, and which can store the data.

Furthermore, as a result of allocating a storage area of a predetermined size in a RAM as a display band buffer, the applicability of a reading display is improved, in particular, by making this storage area variable by an operator, and it is possible to deal with any image reading system.

Furthermore, the relationship between the size of actual image data read by a scanner and the size of the display band buffer is determined, and the actual image data is displayed on the basis of the determination result. As a consequence, flexible reading display based on the size of the actual image data becomes possible.

In particular, when it is determined that the actual image data is smaller than the size of the display band buffer, the actual image data is collectively displayed. When it is determined that the actual image data is larger than the size of the display band buffer, the actual image data is displayed in such a manner as to be divided on the basis of the size of the display band buffer. Therefore, it is possible to efficiently display the actual image data with a small display band buffer.

Furthermore, it is determined whether or not an input of operation for canceling the reading by the scanner is made. When it is determined that the input is made, the image data stored in the RAM is discarded, allowing the RAM to be efficiently used.

Furthermore, in this embodiment, when the amount of the actual image data to be input from a scanner is larger than the size of the display band buffer, the actual image data which is received is stored in such a manner as to be divided according to the size of the display band buffer, and the image data by the amount corresponding to the divided image data stored in the display band buffer is displayed in sequence on the viewer. As a result, even when the size of the display band buffer cannot be sufficiently obtained, the actual image data can be reliably displayed on the viewer.

(Second Embodiment)

In the above-described first embodiment, the image read by a scanner is always compressed and stored in a handheld personal computer. Therefore, it may be difficult to store the read image maintained at a high image quality. Furthermore, since the storage of the image is delayed by the length of time corresponding to the time required for a compression process, this sometimes hinders the speedup of the reading. In this embodiment, to achieve a higher quality of an image and a higher speed of reading, a reading process appropriate for the available memory is performed.

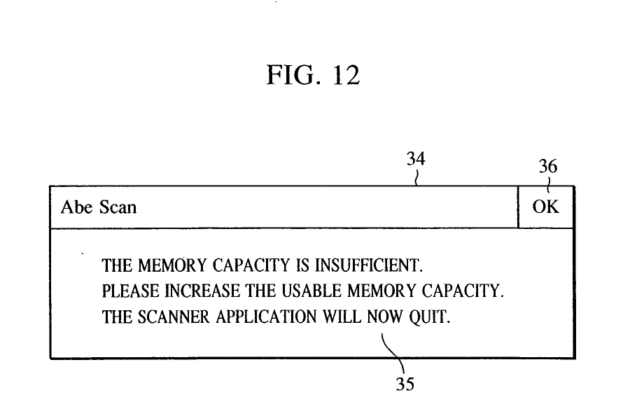

FIG. 12 shows an insufficient available memory error message displayed on the main window 24 of the scanner application 20. Referring to FIG. 12, reference numeral 34 denotes an insufficient available memory error message, which is composed of a message character string 35 and an OK button 36. This message is displayed when the size of the available memory (the RAM 11) of the handheld personal computer 1 is insufficient and when the size of the available memory required to store image data read with the scanning settings at that time is insufficient. When the OK button 36 is clicked on, the scanner application 20 is terminated.

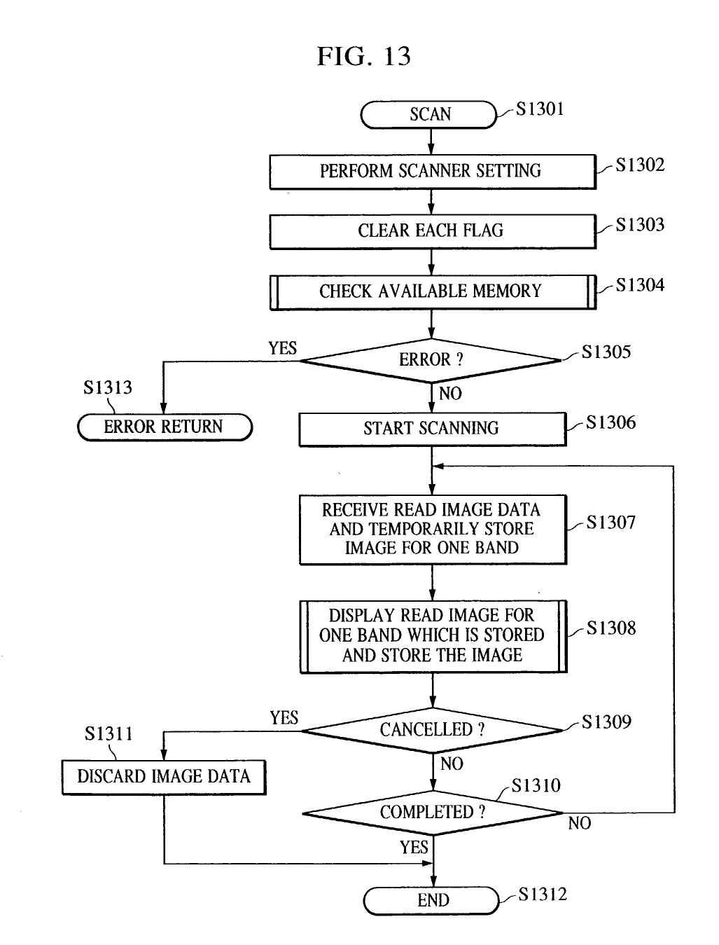

FIGS. 13, 14, and 15 are flowcharts showing the operation (process) of this embodiment. The operation of this embodiment will now be described with reference to these figures.

FIG. 13 is a flowchart showing a process after the operation button 29 is clicked on and reading is started. The process procedure shown in this flowchart is performed by a scanner application.

Initially, in a state in which the scanner 5 is on standby, when the operation button 29 is clicked on and scanning is started (S1301), scanning settings of the scanner 5 are performed in accordance with the scanning settings on the main window 24 (S1302), and an error flag and a compression flag are cleared (S1303), after which the checking of the available memory is performed (S1304). When an error has occurred in the checking of the available memory (i.e., the error flag is set) (S1305), the reading process is stopped, and an error is returned (S1313). In the case of an error in the checking of the available memory in this manner, since scanning is not possible, the reading, is stopped forcedly, thereby preventing the OS from malfunctioning.

When an error has not occurred in step S1305 (i.e., the error flag is cleared), the reading of the original document which is set in the original-document insertion slot 6 is started (S1306).

Then, the image data for one band, which is read by the scanner 5, is received, and the image data for one band (1 MB) is temporarily stored in the display band buffer (the program execution area of the RAM 11 which is a memory) (S1307).

Based on this image data for one band which is stored, the read image is displayed on the viewer 25. At this time, for example, only the image of the area 37 shown in FIG. 9 is displayed. Then, the image data is compressed and is stored in the data storing area of the memory (the RAM 11) (S1308).

During the reading, when the operation button 29 is clicked on (cancel information is input) and the reading of the image is stopped (step S1309), the image data which has been read and stored thus far is discarded (step S1311), and the process returns to the main window 24 (step S1312).

When the reading of the image continues in step S1309 and when the reading is not completed (step S1310), the process returns to step S1307, where the reading continues. Then, in step S1308 in the next loop, only the image of the area 38 is stored in the display band buffer and is displayed. That is, the image of the area 37 is erased from the screen, and only the image of the area 38 is displayed for preview.

When the reading of the image is completed in step S1310, the process returns to the main window 24 (S1312).

When the scanner application 20 receives an error return (step S1313), the scanner application 20 is terminated. When the scanner application 20 receives a return other than an error (step S1312), the process returns to the main window 24.

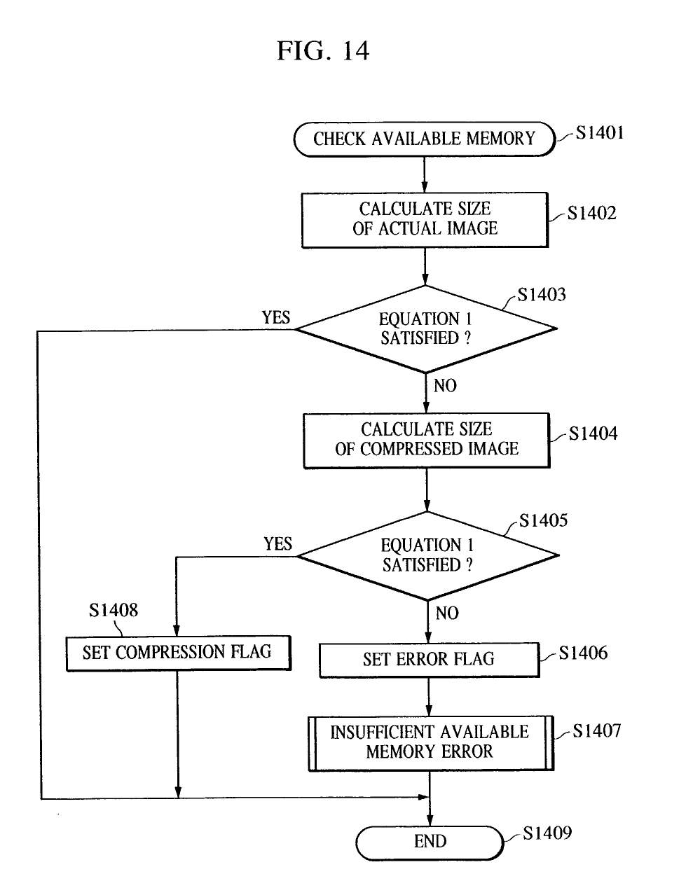

FIG. 14 is a flowchart showing a process in the checking of available memory in step S1304 in FIG. 13. In a state in which the scanner 5 is on standby, when the operation button 29 is clicked on and scanning is started, and the checking of the available memory is started (step S1401), the size of the image data of the actual image when the original document is read with the scanning settings at that time is calculated (step S1402). Next, the following condition is checked in step S1403:

the free space of the data storing area of the memory (the RAM 11)>(the necessary memory capacity+1) [MB] (equation 1).

When the available memory (the RAM 11) can be allocated, the process proceeds to the next step (step S1409). The right side of equation 1 shows (the necessary memory capacity+1), but the “1” is a margin and is usually not used.

In step S1403, when the available memory (the RAM 11) is not sufficient, the size of the image data when the actual image obtained by reading the original document with the scanning settings is compressed is calculated (step S1404), and equation 1 is checked (step S1405). When the available memory (the RAM 11) can be allocated, the compression flag is set (step S1408), and the process proceeds to the next process (step S1409).

In step S1405, when the available memory (the RAM 11) is insufficient, the error flag is set (step S1406), and the insufficient available memory error message 34 is displayed (step S1407). When the OK button 36 is clicked on, the process proceeds to the next process (step S1409).

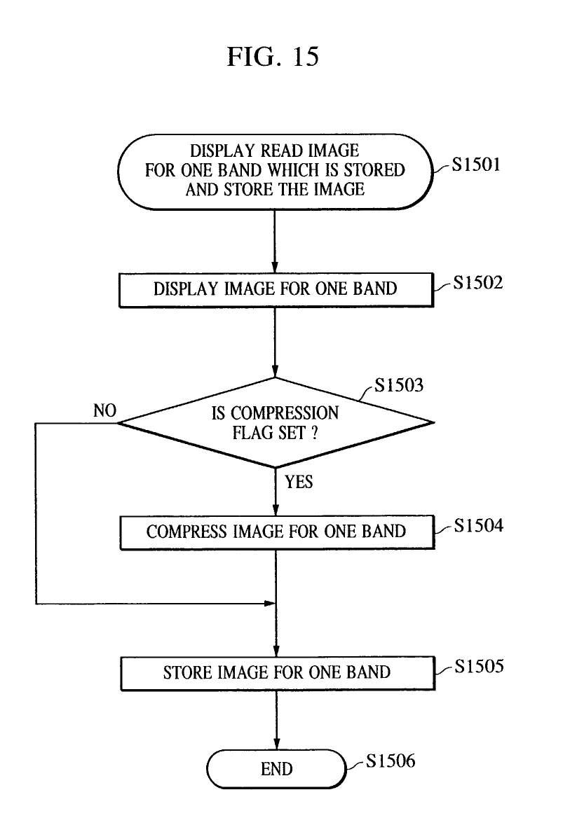

FIG. 15 is a flowchart showing a process for displaying an image for one band, which is read in step S1308 in FIG. 13, and for storing the image.

In a state in which the scanner 5 is on standby, the operation button 29 is clicked on, and scanning is started. Based on the image data for one band, which is temporarily stored in the display band buffer, step S1501 is started.

Initially, based on the image data for one band, which is temporarily stored in the display band buffer, the read image for one band is drawn and displayed on the viewer 25 (step S1502).

Next, when the compression flag is set (step S1503), the read image for one band (the image data stored in the display band buffer) displayed in step S1502 is compressed in accordance with the JPEG compression format (step S1504).

This compressed image for one band is stored in the data storing area of the memory (the RAM 11) (step S1505), and the process proceeds to the next process (step S1506).

When it is determined in step S1503 that the compression flag is cleared, the image for one band is stored in the data storing area of the memory (the RAM 11) (step S1505). In step S1505, when the compression flag is set and if an image formed of previous plural bands, which has already been stored, exists, one band is newly added to this image, and this is stored as a combined compressed image (step S1505).

When the compression flag is cleared and if an image formed of previous plural bands, which has already been stored, exists, one band is newly added to this image, and this is stored as an actual combined image (step S1505).

After the image is stored, the process proceeds to the next process, and a series of processes in step S1308 is terminated (step S1506).

Next, a description is given of an example of the operation of the image reading system in accordance with the above-described processes of FIGS. 13 to 15.

It is assumed that the free space of the data storing area within the RAM 11 of the handheld personal computer 1 is 2 MB. In this state, when the scanner application 20 is activated with the construction of FIG. 1 and the scanning settings shown in FIG. 5 are performed, the size of the actual image is calculated as approximately 0.085 MB, and based on equation 1, 1.085 MB of the free space of the data storing area of the memory (the RAM 11) is required.

In this state, when the operation button 29 is clicked on and reading is started, the process proceeds from step S1301 in FIG. 13 to steps S1302, S1303, and S1304.

In the flowchart showing processes in the available memory check in FIG. 14, the determination in equation 1 in step S1403 becomes YES, and the process proceeds to step S1409.

Then, the process proceeds to NO in step S1305 in FIG. 13, and reading is started (step S1306). During the reading, in step S1308, the process proceeds to step S1501 in FIG. 15. Since the compression flag is cleared in step S1503, the read image for one band is stored as an actual image in step S1505, and the process proceeds to step S1506.

When the reading is completed in step S1310 in FIG. 13, the process proceeds to step S1312, and the process returns to the main window 24. FIG. 6 shows the display contents of the main window during the reading in the above-described example.

Another example of the operation will now be described. It is assumed that the free space of the data storing area within the RAM 11 of the handheld personal computer 1 is 2 MB. In this state, when the scanner application 20 is activated with the construction of FIG. 1 and the scanning settings shown in FIG. 7 are performed, the size of the actual image is calculated as approximately 5.7 MB, and based on equation 1, 6.7 MB of the free space of the data storing area of the memory (the RAM 11) is required. Furthermore, when this actual image is compressed in accordance with the JPEG format, the size of the compressed image is calculated as approximately 0.8 MB, and based on equation 1, 1.8 MB of the free space of the data storing area of the memory (the RAM 11) is required.

In this state, when the operation button 29 is clicked on and reading is started, the process proceeds from step S1301 in FIG. 13 to steps S1302, S1303, and S1304.

In the flowchart showing processes in the available memory check in FIG. 14, the determination for equation 1 in step S1403 becomes NO, the determination for equation 1 in step S1405 becomes YES, the compression flag is set in step S1408, and the process proceeds to step S1409.

Then, the process proceeds to NO in step S1305 in FIG. 13, and reading is started (step S1306). During the reading, in step S1308, the process proceeds to step S1401 in FIG. 14. Since the compression flag is set in step S1403, the read image for one band is compressed (S1404), this compressed image is stored as a compressed image (S1405), and the process proceeds to step S1506.

When the reading is completed in step S1310 in FIG. 13, the process proceeds to step S1312, and the process returns to the main window 24. FIG. 8 shows the display contents of the main window during the reading in the above-described example.

In this manner, even when the size of the actual image to be read is larger than the free space of the memory (the RAM 11) and the available memory becomes insufficient, the reading process can be continued with those scanning settings, and the read image can be stored in the memory. When the size of the actual image to be read is smaller than the free space of the memory (the RAM 11), the actual image which is read is stored as it is in the memory, and it is possible to prevent the image quality from becoming deteriorated.

In the foregoing description, the operation in each state of the present invention has been described. In this embodiment, the size of the actual image to be read by the scanner 5 is calculated with the scanning settings at that time, and the size is compared with the free space of the data storing area of the memory (the RAM 11). When the size of the actual image is larger, the read image is compressed and stored. When the size of the actual image is smaller, the read image is stored directly as an actual image. Therefore, it is possible to prevent the image quality from becoming deteriorated, and it is possible to perform reading at high speed with desired scanning settings regardless of the size of the available memory.

(Other Embodiments)

Although in the above-described embodiments the scanner 5 is used as an example of the image input device, the present invention is not limited to this example. For example, an image input device having the same functions, such as a digital camera, can be effectively used. In addition to a color scanner, a monochrome scanner can also be used. In addition to a sheet-feed-type scanner, any device which serves the same purpose, such as a flat-bed-type scanner, can also be effectively used.

In the above-described embodiments, Microsoft Windows CE is used as an example of the OS. In addition to this OS, the present invention can be realized in any OS as long as the same construction is adopted.

In the above-described embodiments, a USB interface is used as an example of the interface between the handheld personal computer 1 and the scanner 5. However, in addition to this interface, any interface can be used as long as the same construction is adopted.

In the above-described embodiments, the size of the display band buffer is set to 1 MB as an example. However, in addition to this example, the construction may be formed with any size according to the particular hardware and system.

In the above-described embodiments, a handheld personal computer is used as a host. In addition, the present invention can also be applied to other devices having an image input function, such as a personal computer having an HDD, a facsimile machine, and a digital combined device, and to a system having an image input function.

Furthermore, the present invention can also be applied to a computer system in which a printer is connected to a handheld personal computer of the above-described embodiments or a personal computer having an HDD so that image data read by a scanner can be printed by the printer. In this case, the copied application running on the personal computer performs reading control similar to that of the above-described embodiments, whereas the copied application controls the output to the printer via a printer driver, making it possible to obtain the printed results of the entire image while displaying the read image in units of bands in a manner similar to the above-described embodiments.

Furthermore, the present invention can be applied to an image,transmission system in which a data communication device having a network function or a facsimile function is connected to a handheld personal computer of the above-described embodiments or a personal computer having an HDD so that image data read by a scanner can be output by the data communication device. In this case, a communication application running on the personal computer performs reading control similar to that of the above-described embodiments, whereas the communication application transmits the compressed image to the data communication device and controls the transmission of the data communication device, making it possible to transmit the entire image while displaying the read image in units of bands in a manner similar to the above-described embodiments.

In the above-described embodiments, JPEG, which is one of lossless compression formats, is used as an example of the compression format. However, in addition to this example, any compression format which can be realized with the same construction can be used. In addition to the lossless compression format, a lossy compression format can be used.

The present invention can also be realized in such a way that a storage medium, in which program code of software which realizes the functions of the above-described embodiments is stored, is supplied to a system or a device, and a computer (or a CPU or an MPU) of that system or that device reads and executes the program code stored in the storage medium (for example, the RAM 11 in the above-described embodiments).

In this case, the program code itself which is read from the storage medium realizes the functions of the above-described embodiments, and the storage medium having the program code stored thereon constitutes the present invention. As storage media for supplying program code, for example, a floppy disk, a hard disk, an optical disk, a magneto-optical disk, a CD-ROM, a CD-R, magnetic tape, a nonvolatile memory card, and a ROM can be used. The functions of the embodiments are implemented by executing the read program code by the computer. Alternatively, in accordance with instructions of the program code, an OS (Operating System) running on the computer performs part of or the entirety of the actual processing, thereby implementing the functions of the embodiments. This arrangement also falls within the scope of the present invention.

In addition, program code read from a storage medium is written into a memory incorporated in a function expansion board inserted into a computer or in a function expansion unit connected to a computer. Thereafter, a CPU provided in the function expansion board or the function expansion unit performs part or the entirety of the actual processing in accordance with the instructions from the program code, thereby implementing the functions of the above embodiments. This arrangement also falls within the scope of the present invention.

Similarly, the present invention can also be realized in such a way that program code is supplied to a system or a device by downloading the program code from an external device (for example, a server device) in which program code of software for realizing the functions of the above-described embodiments is stored and that a computer (or a CPU or an MPU) of that system or that device reads and executes the program code stored in a storage medium (for example, the RAM 11 in the above-described embodiments).

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image input control method for use with an information processing apparatus which can communicate with an image input device for inputting image data via a communication medium and which has storage means and display means, said image input control method comprising:
a first storing step of storing image data received from said image input device in said storage means;
a display step of displaying on said display means the image data stored in said storage means in said first storing step;
a compression step of compressing the image data stored in said storage means in said first storing step after the image data is displayed in said display step; and
a second storing step of storing in said storage means the image data compressed in said compression step.

2. An image input control method according to claim 1, wherein a storage area of a predetermined size in said storage means is allocated as a display storage section used in said first storing step.

3. An image input control method according to claim 2, further comprising a first determination step of determining a relationship between a size of input image data input by said image input device and a size of said display storage section,
wherein said input image data is displayed in said display step based on a determination result of said first determination step.

4. An image input control method according to claim 3, wherein, when it is determined in said first determination step that the size of said input image data is smaller than the size of said display storage section, said input image data is collectively displayed in said display step, and when it is determined in said first determination step that the size of said input image data is larger than the size of said display storage section, said input image data is displayed in said display step in such a manner as to be divided based on the size of said display storage section.

5. An image input control method according to claim 4, wherein said image input device is controlled so that said input image data is stored in sequence in said display storage section.

6. An image input control method according to claim 5, further comprising a second determination step of determining whether cancellation information for canceling the image input by said image input device is input by an operator,
wherein, when it is determined in said second determination step that the cancellation information is input, the image data stored in said storage means is discarded.

7. An image input control method according to claim 1, wherein said image input device is a scanner for creating input image data by reading an original-document image.

8. An image input control method for use with an information processing apparatus which can communicate with an image input device for inputting image data via a communication medium and which has storage means, said image input control method comprising:
a computation step of computing an amount of image data input by said image input device;
a first determination step of determining a relationship between the amount of image data computed in said computation step and a size of a free space of said storage means;
a compression step of compressing said image data received from said image input device when it is determined in said first determination step that the amount of image data is larger than the size of the free space of said storage means; and
a storing step of storing in said storage means the image data compressed in said compression step.

9. An image input control method according to claim 8, wherein, when it is determined in said first determination step that the amount of image data is smaller than the size of the free space of said storage means, said image data received from said image input device is stored in said storage means in said storing step.

10. An image input control method according to claim 8, further comprising:
a second determination step of determining the relationship between an amount of compressed image data compressed in said compression step and the size of the free space of said storage means; and
a control step of stopping the input of the image data by said image input device when it is determined in said second determination step that the amount of compressed image data is larger than the size of the free space of said storage means.

11. An image input control method for use with an information processing apparatus which can communicate with an image input device for inputting image data via a communication medium and which has storage means and display means, said image input control method comprising:
a storing step of sequentially receiving image data input from said image input device and storing said input image data in said storage means; and
a display step of displaying on said display means the image data stored in said storage means,
wherein, when an amount of input image data is larger than a size of said storage means, said input image data is stored in said storing step in such a manner as to be divided according to the size of said storage means, and the image data is displayed in sequence, in said display step, by the amount corresponding to divided input image data stored in said storage means.

12. An image input control method according to claim 11, wherein said image input device is a scanner for sequentially creating the input image data by reading an original-document image, the input image data of a size corresponding to said storage means is stored as divided image data in said storing step, and said divided image data is displayed in sequence in units of rectangular images in said display step.

13. An image input control method according to claim 11, wherein the divided image data displayed in said display step is stored in such a manner as to be compressed in another storage means which is different from said storage means.

14. An image input control method for use with an information processing apparatus which can communicate with an image input device for inputting image data via a communication medium and which has storage means and display means, said image input control method comprising:
a first storing step of storing said input image data in such a manner as to be divided in said storage means according to a size of said storage means when an amount of data of input image data by said image input device is larger than the size of said storage means;
a display step of sequentially displaying the image data by the amount corresponding to divided image data stored in said storage means in said first storing step;
a compression step of compressing the image data stored in said storage means in said first storing step after the image data is displayed in said display step; and
a second storing step of storing the image data compressed in said compression step in said storage means.

15. An information processing apparatus which can communicate with an image input device for inputting image data via a communication medium, said information processing apparatus comprising:
first storage means for storing image data received from said image input device;
display means for displaying the image data stored in said first storage means;
compression means for compressing the image data stored in said first storage means after the image data is displayed by said display means; and
second storage means for storing the image data compressed by said compression means.

16. An information processing apparatus according to claim 15, wherein, for said first storage means, a storage area of a predetermined size is allocated as a display storage section.

17. An information processing apparatus according to claim 16, further comprising first determination means for determining a relationship between a size of image data input by said image input device and a size of said display storage section,
wherein said display means displays said input image data according to a determination result of said first determination means.

18. An information processing apparatus according to claim 17, wherein, when said first determination means determines that said input image data is smaller than the size of said display storage section, said display means collectively displays said input image data, and when said first determination means determines that said input image data is larger than the size of said display storage section, said display means displays said input image data in such a manner as to be divided based on the size of said display storage section.

19. An information processing apparatus according to claim 18, wherein said image input device is controlled so that said input image data is stored in sequence in said display storage section.

20. An information processing apparatus according to claim 19, further comprising second determination means for determining whether cancellation information for canceling the image input by said image input device is input by an operator,
wherein, when said second determination means determines that the cancellation information is input, the image data stored in said second storage means is discarded.

21. An information processing apparatus according to claim 14, wherein said image input device is a scanner for sequentially creating input image data by reading an original-document image.

22. An information processing apparatus which can communicate with an image input device for inputting image data via a communication medium and which has storage means, said information processing apparatus comprising:
computation means for computing an amount of image data which is input by said image input device;
first determination means for determining a relationship between the amount of said image data computed by said computation means and a size of a free space of said storage means;
compression means for compressing said image data received from said image input device when said first determination means determines that the amount of said image data is larger than the size of the free space of said storage means; and
storage means for storing the image data compressed by said compression means.

23. An information processing apparatus according to claim 22, wherein, when said first determination means determines that the amount of said image data is smaller than the size of the free space of said storage means, said storage means stores therein said image data received from said image input device.

24. An information processing apparatus according to claim 22, further comprising:
second determination means for determining the relationship between an amount of said compressed image data compressed by said compression means and the size of the free space of said storage means; and
control means for stopping the input of the image data by said image input device when said second determination means determines that the amount of said compressed image data is larger than the size of the free space of said storage means.

25. An information processing apparatus which can communicate with an image input device for inputting image data via a communication medium, said information processing apparatus comprising:
storage means for sequentially receiving and storing image data which is input from said image input device; and
display means for displaying the image data stored in said storage means,
wherein, when an amount of image data is larger than a size of the said storage means, said storage means stores said input image data in such a manner as to be divided according to the size of the storage means, and said display means sequentially displays the image data by the amount corresponding to divided image data stored in said storage means.

26. An information processing apparatus according to claim 25, wherein said image input device is a scanner for sequentially creating the input image data by reading an original-document image, said storage means stores therein the input image data of the size of the storage means as divided image data, and said display means sequentially displays said divided image data in units of rectangular images.

27. An information processing apparatus according to claim 25, wherein the divided image data displayed by said display means is stored in such a manner as to be compressed in another storage means which is different from said storage means.

28. An information processing apparatus which can communicate with an image input device for inputting image data via a communication medium and which has storage means and display means, said information processing apparatus comprising:
first storage means for storing input image data in such a manner as to be divided in said storage means according to a size of the storage means when an amount of the image data which is input by said image input device is larger than the size of the storage means;
display means for sequentially displaying image data by the amount corresponding to divided image data stored by said first storage means;
compression means for compressing the image data stored by said first storage means after the image data is displayed by said display means; and
second storage means for storing the image data compressed by said compression means.

29. A computer-readable storage medium having stored thereon program code for an image input control method in an information processing apparatus which can communicate with an image input device for inputting image data via a communication medium and which has storage means and display means, said program code comprising:
first storing code for storing image data received from said image input device in said storage means;
display code for displaying on said display means the image data stored in said storage means by said first storing code;
compression code for compressing the image data stored in said storage means by said first storing code after the image data is displayed by said display code; and
second storing code for storing in said storage means the image data compressed by said compression code.

30. A computer-readable storage medium having stored thereon program code for an image input control method in an information processing apparatus which can communicate with an image input device for inputting image data via a communication medium and which has storage means, said program code comprising:
computation code for computing an amount of image data input by said image input device;
first determination code for determining a relationship between the size of the amount of said image data computed by said computation code and a size of a free space of said storage means;
compression code for compressing said image data received from said image input device when said first determination code determines that the amount of said image data is larger than the size of the free space of said storage means; and
storing code for storing in said storage mean the image data compressed by said compression codes.

31. A computer-readable storage medium having stored thereon program code for an image input control method in an information processing apparatus which can communicate with an image input device for inputting image data via a communication medium and which has storage means and display means, said program code comprising:
storing code for sequentially receiving image data input from said image input device and storing the image data in said storage means; and
display code for displaying on the display means the image data stored in said storage means,
wherein, when an amount of said input image data is larger than a size of said storage means, said storing code stores said input image data in such a manner as to be divided according to the size of said storage means, and said display code sequentially displays the image data by the amount corresponding to divided input image data stored in said storage means.

32. A computer-readable storage medium having stored thereon program code for an image input control method in an information processing apparatus which can communicate with an image input device for inputting image data via a communication medium and which has storage means and display means, said program code comprising:
first storing code for storing said input image data in such a manner as to be divided in said storage means according to a size of said storage means when an amount of image data input from said image input device is larger than the size of said storage means;
display code for sequentially displaying on said display means the image data by the amount corresponding to divided image data stored in said storage means in said first storing step;
compression code for compressing the image data stored in said storage means by said first storing code after the image data is displayed by said display code; and
second storing code for storing in said storage means the image data compressed by said compression code.

33. A program for executing an image input control method in an information processing apparatus which can communicate with an image input device for inputting image data via a communication medium and which has storage means and display means, said program comprising:
a first storing step of storing image data received from said image input device in said storage means;
a display step of displaying on said display means the image data stored in said storage means in said first storing step;
a compression step of compressing the image data stored in said storage means in said first storing step after the image data is displayed in said display step; and
a second storing step of storing in said storage means the image data compressed in said compression step.

34. A program for executing an image input control method in an information processing apparatus which can communicate with an image input device for inputting image data via a communication medium and which has storage means, said program comprising:
a computation step of computing an amount of image data input by said image input device;
a first determination step of determining a relationship between the amount of said image data computed in said computation step and a size of the free space of said storage means;
a compression step of compressing said image data received from said image input device when it is determined in said first determination step that the amount of said image data is larger than the size of the free space of said storage means; and
a storing step of storing in said storage means the image data compressed in said compression step.

35. A program for executing an image input control method in an information processing apparatus which can communicate with an image input device for inputting image data via a communication medium and which has storage means and display means, said program comprising the steps of:
a storing step of sequentially receiving image data input from said image input device and storing the image data in said storage means; and
a display step of displaying on said display means the image data stored in said storage means,
wherein, when an amount of said input image data is larger than a size of said storage means, said input image data is stored in said storing step in such a manner as to be divided according to the size of said storage means, and said display step sequentially displays the image data by the amount corresponding to divided input image data stored in said storage means.

36. A program for executing an image input control method in an information processing apparatus which can communicate with an image input device for inputting image data via a communication medium and which has storage means and display means, said program comprising:
a first storing step of storing said input image data in such a manner as to be divided in said storage means according to a size of said storage means when an amount of image data input from said image input device is larger than the size of said storage means;
a display step of sequentially displaying on said display means the image data by the amount corresponding to divided image data stored in said storage means in said first storing step;
a compression step of compressing the image data stored in said storage means in said first storing step after the image data is displayed in said display step; and
a second storing step of storing in said storage means the image data compressed in said compression step.
